(19) United States
(12) Patent Application Publication
(10) Pub. No.: US 2026/0289471 A1
(43) Pub. Date: Sep. 24, 2026

(54) COTTON SPINNING MILL PERFORMANCE AND OPTIMIZATION LLLLLSYSTEM

(71) Applicant: COTTON COUNCIL INTERNATIONAL, Washington, DC (US)

(72) Inventors: Bruce A. Atherley, Washington, DC (US); Joerg Bauersachs, Dubai (AE)

(21) Appl. No.: 19/484,637

(22) PCT Filed: May 29, 2024
(86) PCT No.: PCT/US2024/031511

§ 371 Date: Nov. 14, 2025

Related U.S. Application Data
(60) Provisional application No. 63/504,766, filed on May 29, 2023.

(51) Int. Cl. G06Q 10/0639; G06Q 50/04

(52) U.S. Cl. CPC G06Q 10/06393; G06Q 50/04

(57) ABSTRACT

A mill performance index system with raw cotton yarn production data acquisition masking modules, KPI analysis and reporting modules and confidentiality measures is disclosed for identifying KPI optimization targets and confidentially providing comparative industry rankings. KPI performance reporting and comparison is provided with visual reporting elements including tachometer displays that indicate relative and absolute KPI rankings with competitive entities while maintaining data confidentiality.

### TECHNICAL FIELD

Exemplary embodiments of the present invention relate generally to the field of manufacturing performance measurement, reporting and improvement, and more specifically to software and hardware systems, and related methods of use, of collecting, normalizing, analyzing, displaying and reporting performance metrics in field of cotton spinning and methods of optimizing the operations of the same.

### BACKGROUND OF THE INVENTION

The following description of the background of the invention is provided simply as an aid in understanding the invention and is not admitted to describe or constitute prior art to the invention.

Many mills in the cotton yarn spinning industry are focused on the maintenance and improvement of their internal processes and factors that contribute to productivity, product quality and profitability. However, it is common for yarn mills to lack an understanding of and insight into the competitive advantages and disadvantages of their peers, and therefore find it difficult to assess the competitiveness of their operations relative to their competitors. Visibility into areas of disadvantage (i.e., those needing improvement vis-à-vis competitor performance) is needed in order for many mills to improve the main categories of focus (e.g., productivity, product quality/performance and profitability). It has been found that many cotton mills desire to know how their performance compares to other peer group competitors in the industry on a macro level down to product level.

One difficulty in obtaining useful competitor benchmarking data is the general avoidance of disclosing operational details between competitors. This reluctance has made it difficult for any individual mill to reliably obtain benchmarking data for any key performance indicator (KPI) on an industry level. Therefore, many firms have difficulty in quantifying the success of their process improvement efforts due to a lack of information sharing amongst competitors. It has been found that a method of confidentially sharing mill operational data amongst competitors in the industry without compromising data security is a need.

It is therefore an unmet need in the prior art for a cotton spinning mill performance and optimization system that accounts for industry level performance metrics. No known references, taken alone or in combination, are seen as teaching or suggesting the presently claimed invention.

### BRIEF SUMMARY OF THE INVENTION

The following provides a summary of certain example implementations of the disclosed technology. This summary is not an extensive overview and is not intended to identify key or critical aspects or elements of the disclosed technology or to delineate its scope. However, it is to be understood that the use of indefinite articles in the language used to describe and claim the disclosed technology is not intended in any way to limit the described technology. Rather the use of “a” or “an” should be interpreted to mean “at least one” or “one or more”.

One implementation of the disclosed technology provides a mill performance index system. An exemplary embodiment thereof is provided which includes a mill performance index computing system, a plurality of participating mills, and a plurality of users accessing the mill performance index computing system via remote computing devices.

An exemplary embodiment of the present invention includes a mill performance index computing system having a memory unit and a processor. The mill performance index computing system includes data storage for data including raw mill data and display data. Web and applications servers interact with remote computing devices to facilitate mill performance data acquisition and mill KPI reporting and analysis.

It should be appreciated that all combinations of the foregoing concepts and additional concepts discussed in greater detail below (provided such concepts are not mutually inconsistent) are contemplated as being part of the technology disclosed herein and may be implemented to achieve the benefits as described herein. Additional features and aspects of the disclosed system, devices, and methods will become apparent to those of ordinary skill in the art upon reading and understanding the following detailed description of the example implementations. As will be appreciated by the skilled artisan, further implementations are possible without departing from the scope and spirit of what is disclosed herein. Accordingly, the descriptions provided herein are to be regarded as illustrative and not restrictive in nature.

### BRIEF DESCRIPTION OF THE DRAWINGS

The accompanying drawings, which are incorporated into and form a part of the specification, schematically illustrate one or more example implementations of the disclosed technology and, together with the general description given above and detailed description given below, serve to explain the principles of the disclosed subject matter, and wherein:

FIG. 1 is a schematic view of an exemplary embodiment of a cotton spinning mill performance index (MPI) system.

FIG. 2 is a schematic view of an exemplary embodiment of an MPI system wherein data pathing is shown for a single mill utilizing a mill performance data acquisition module.

FIG. 3 is a simplified flow diagram illustrates the data acquisition and reporting process in an embodiment of the MPI system

FIG. 4 is a simplified flow diagram illustrates the data acquisition and reporting process in a further exemplary embodiment of the MPI system, wherein the data acquisition step.

FIG. 5 is a flow diagram illustrating an exemplary embodiment of such an initial mill configuration step.

FIG. 6 is a flow diagram of an exemplary embodiment of the simplified use of a reporting module.

FIG. 7 is an exemplary depiction of a mill performance index report.

FIG. 8 is an exemplary embodiment of a material yield display KPI visualization.

FIG. 9 is an exemplary tabular display of a single KPI depicted through a mill KPI reporting analysis module on a remote computing device.

FIG. 10 is an exemplary embodiment of a module shown in connection with an exemplary display for product-level machine productivity report.

FIG. 11 is an exemplary embodiment of a labor productivity report shown with a tachometer display.

FIG. 12 is an exemplary use of a mill level KPI report is shown in connection with a report.

FIG. 13 is a schematic representation of a preferred embodiment of an MPI system.

### DETAILED DESCRIPTION

Example implementations are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the disclosed technology. Accordingly, the following implementations are set forth without any loss of generality to, and without imposing limitations upon, the claimed subject matter.

The examples discussed herein are examples only and are provided to assist in the explanation of the apparatuses, devices, systems, and methods described herein. None of the features or components shown in the drawings or discussed below should be taken as required for any specific implementation of any of these the apparatuses, devices, systems or methods unless specifically designated as such. For ease of reading and clarity, certain components, modules, or methods may be described solely in connection with a specific Figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Similarly, the use of the word “or” is intended to be non-exclusive unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, or groups thereof.

Embodiments of the invention are described herein with reference to illustrations that are schematic illustrations of idealized embodiments (and intermediate structures) of the invention. As such, variations from the shapes of the illustrations as a result, for example, of manufacturing techniques or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments of the disclosed system and methods are provided in part to advance the development of manufacturing facilities and improve the performance of the processes implemented by those facilities. With particular attention paid to the manufacture of cotton yarns, producers are engaged in the continuous development and improvement of their internal manufacturing processes to increase product quality and yields, as well as improved margins brought about by efficiencies in areas such as energy use and labor productivity. While many yarn manufacturers are skilled and knowledgeable with respect to internal systems and processes, there is a deficit of information with regard to industry-wide competitive comparison.

In a preferred embodiment, comparative metrics are provided in such a way wherein manufacturers are able to focus their improvement efforts in specific process areas. Furthermore, such metrics can also be useful for making objective statements about the characteristics of a particular manufacturer's product relative to the market without sacrificing confidentiality or competitive advantages, while also limiting advertising tort liability risks.

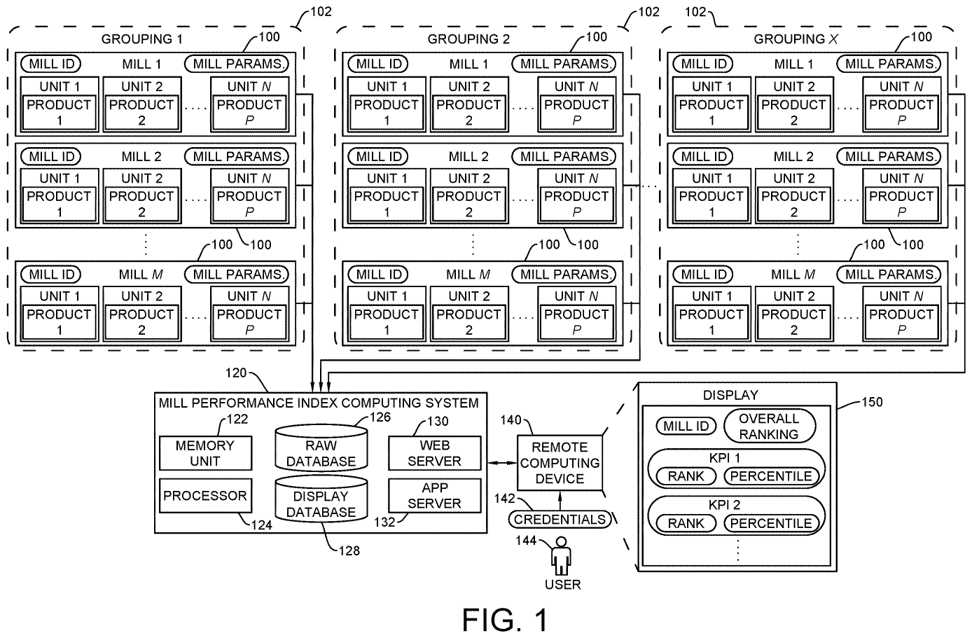

Turning first to FIG. 1, a schematic view of an exemplary embodiment of a cotton spinning mill performance index (MPI) system is shown. In this embodiment, a plurality of cotton spinning mills 100 participate in the implementation of an indexing system whereby performance data is collected on a number of key performance indicators (KPIs). Each mill 100 preferably represents a single physical cotton spinning mill location and can be organized into related groupings of mills, such as grouping 1, grouping 2, . . . up through grouping X, as shown at 102. These mill groupings 102 may encompass any number of mills 100 such as a single mill, or two or more mills (i.e., up to some mill number M). In a preferred embodiment, mill groups 102 are used to maintain mill level KPI visibility across physically separate but commonly owned and operated mills, for instance. Similarly, a mill group may only contain a single mill, for example. Generally, the mill group 102 is used at the authorization/access level when making use of the system, as will be described fully in more detail herein below.

In a preferred embodiment, each mill 100 participating in the MPI system has a unique mill identification number, a set of mill level parameters, and one or more units (e.g., Unit 1, Unit 2, . . . up to Unit N). A mill unit is defined in such a way that isolates a machine, production personnel and an associated product during a reporting period. In a preferred embodiment, the MPI system is configured to convert raw performance data to KPI data reported at three primary levels: (1) the mill level; (2) the unit level; and (3) the product level.

Exemplary embodiments of the MPI system are further provided with a mill performance index computing system 120, including at least one memory unit 122 and at least one processor 124. Once the mill level parameters are defined for a mill, the MPI computing system 120 is used to collect raw performance data from the mill for storage in a raw mill data database 126. In some embodiments, the raw mill data database 126 is used to store all data entries received from the mill or mill group users, but is not used to store the results of any calculated or derived KPI. In a preferred embodiment, a separate application or display database 128 may be used to store data such as master mill data, customer data, user data, and KPI data, for instance. Certain implementations of the disclosed MPI computing system 120 may include components such as web servers 130, application servers 132 or a combination thereof, used to provide communication between an MPI computing system and a user, preferably via an application programming interface (API).

It is intended that preferred embodiments of the invention will include system access via one or more remote computing devices 140, such as a personal user device or specially purposed remote terminal, for example. In these implementations, a user 144 will be provided credentialed 142 access to the system to perform a variety of tasks. The scope of the interaction and access available to a given user 144 may be dependent upon the user's account settings or role. In some cases, the user 144 may have data entry or submission privileges, in which case the user is permitted to submit raw mill data to the computing system 120. In other cases, the user 144 may have reporting access, in which case certain information, including KPI data, mill data and comparison data are available via a display 150.

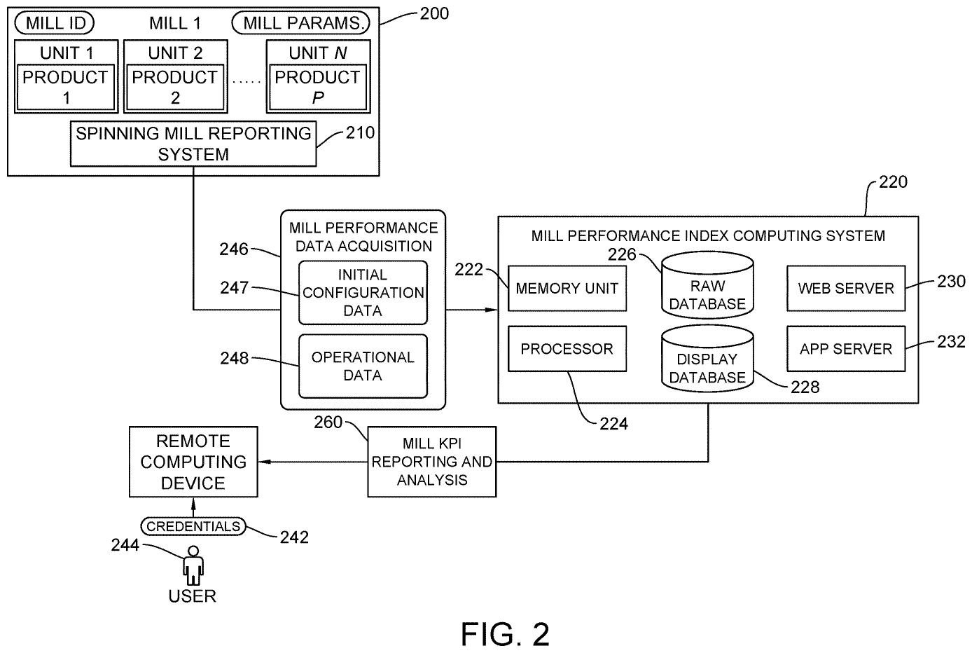

A further depiction of an exemplary use of the MPI system is illustrated in schematic form in connection with FIG. 2, wherein data pathing is shown for a single mill 200 utilizing a mill performance data acquisition (MPDA) module 246. In some implementations, a participating mill 200 may employ one of a number of spinning mill reporting system 210 that are available in the industry. Spinning mill reporting systems 210 are internal systems that provide a number of manufacturing management advantages, such as but not limited to machine and sensor networking and process data collection, management and storage. In a preferred embodiment, a participating mill 200 with spinning mill reporting system 210 capability may be optionally provided with the opportunity to directly output raw reporting data from the spinning mill reporting system 210 to the MPI computing system 220, for instance. This reporting structure may be periodic, continuous, or some combination thereof, depending upon the particular application and reporting system 210 capabilities.

The MPI computing system 220 shown in connection with FIG. 2 is similar to that shown in connection with FIG. 1, having at least one memory unit 222, at least one processor 224, a raw mill data database 226, a display database 228, and communication/access servers (which may be conceptually or physically separate from the memory unit/processor) such as a web server 230 and an application server 232. FIG. 2 also illustrates an embodiment in which an MPDA module 246 is deployed to facilitate mill- or group-level account configuration and the acquisition of standardized, accurate and timely raw mill data. In a preferred embodiment, the MPDA module provides guided data entry to a user that is configuring a mill account. The initial configuration data filter or template 247 is used to define the mill parameters for the mill 200 and set up the N units and P products associated with the mill's manufacturing activities. The operational data filter or template 248 is provided to facilitate the intake of raw mill data during the mill's participation in the use of the MPI system.

In one exemplary implementation, the operational data mask 248 may be embodied as a digital file (such as a Microsoft Excel file, for instance) that contains ordered raw mill data corresponding to a defined operational time period. In a preferred embodiment, the operational data mask 248 includes a series of logic checks that are executed to ensure raw data accuracy, completeness and standardization. Preferably, the operational data mask 248 of the MPDA module 246 will further include features to encourage and facilitate data entry, thereby promoting timely raw data collection.

In another exemplary implementation, the operational data mask 248 is embodied as an automated data acquisition function that receives data from a spinning mill reporting system 210 and performs validation on the imported data before writing to the raw mill data database 226. Some implementations may further provide an operational data mask 248 in the form of a web application interface that combines automated data import, manual data entry and data validation. In a preferred embodiment, all of the aforementioned methods of raw mill data acquisition via the MPDA module 246 are offered to a plurality of participating mills.

As discussed in connection with FIG. 1 and in further detail below, the embodiment shown in connection with FIG. 2 also provides a KPI reporting and analysis module 260 that is accessible to a credentialed 242 user 244 via a remote computing device. In a preferred embodiment, comparative aggregated manufacturing KPI data are stored in the display database 228, in some cases separately from the raw database 226 to reduce the risk of accidental exposure of confidential information between competitors.

In some embodiments, the mill KPI reporting and analysis module 260 is configured to implement one or more artificial intelligence (AI) or machine learning (ML) analysis submodules. The collection of industry-level data for mill production metrics and KPI visibility will facilitate advanced analyses of said data to provide additional KPI links and insights that are desirable to participating mills. In these embodiments, the inclusion of such feedback in the reporting module 260 is considered advantageous. AI/ML models may be used to determine and model relationships between raw mill data inputs and key KPI data to derive unique insights into product quality, mill profitability and product performance, for instance.

As understood by those of skill in the art, AI based classification techniques can vary depending on the desired implementation, without departing from the disclosed technology. For example, AI classification schemes can utilize one or more of the following, alone or in combination: hidden Markov models; recurrent neural networks (RNNs); convolutional neural networks (CNNs); deep learning; Bayesian symbolic methods; general adversarial networks (GANs); support vector machines; image registration methods; or applicable rule-based system. Where regression algorithms are used, they may include but are not limited to a Stochastic Gradient Descent Regressor, a Passive Aggressive Regressor, or other such algorithms.

Machine learning classification models can also be based on clustering algorithms (e.g., a mini-batch K-means clustering algorithm), a recommendation algorithm (e.g., a mini-wise hashing algorithm or Euclidean locality-sensitive hashing (LSH) algorithm), or an anomaly detection algorithm, such as a local outlier factor. Additionally, machine learning models can employ a dimensionality reduction approach, such as, one or more of: a mini-batch dictionary learning algorithm, an incremental principal component analysis (PCA) algorithm, a latent Dirichlet allocation algorithm, a mini-batch K-means algorithm, or other such comparable means.

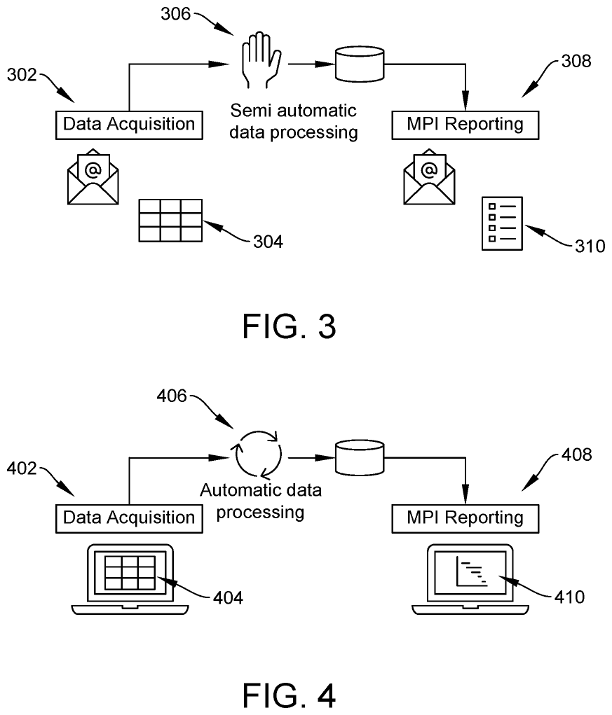

Turning to FIG. 3, a simplified flow diagram illustrates the data acquisition and reporting process in an embodiment of the MPI system. In this embodiment, the data acquisition step 302 occurs periodically via the use of a discrete digital file version of an operational data mask 304. In a preferred embodiment, the reporting period may be set to an interval of three months, for instance. The appropriate mill user will receive a digital file once per reporting period with a request to provide raw mill performance data. In a preferred embodiment the template 303 is a Microsoft Excel file with predetermined data entry fields and internal data validation checks. This request may be implemented through an MPI system portal accessible only with appropriate user credentials and access privileges. Preferably, the completed template is returned before a predetermined date.

The data acquired at 302 is then stored and processed for system-wide reporting at 306. In one embodiment, at a reporting step 308, an MPI report 310 is distributed to participating mills. The MPI report 310 may be embodied in a tabular format containing absolute KPI rankings, whereby each participating mill is only aware of their own mill and unit codes. In some embodiments, this is provided through a secure MPI portal.

Turning now to FIG. 4, a simplified flow diagram illustrates the data acquisition and reporting process in a further exemplary embodiment of the MPI system, wherein the data acquisition step 402 is primarily driven by periodic entries into a secure web-accessible operational data mask 404. In a preferred embodiment, the data mask 404 or template is provided as a single page application accessible from a remote, networked user device, such as but not limited to a desktop personal computing device. Whatever user device is used, it is preferred that the data acquisition mask 404 is accessed only by authenticated users.

The data acquired at 402 is then stored and processed for system-wide reporting at 406. In one embodiment, at a reporting step 408, an MPI report 410 is distributed to participating mills. The MPI report 410 in a preferred embodiment may be embodied in a display tool module that is a mobile-first, reactive web application made accessible to credentialed users on remote computing devices, such as but limited to smartphones, tablets, desktop and laptop personal computers, and other such devices. The MPI report 410 will get available KPIs and filters from the system and, depending on user selected or predetermined filters, request data necessary to display the requested charts/information only from a display database.

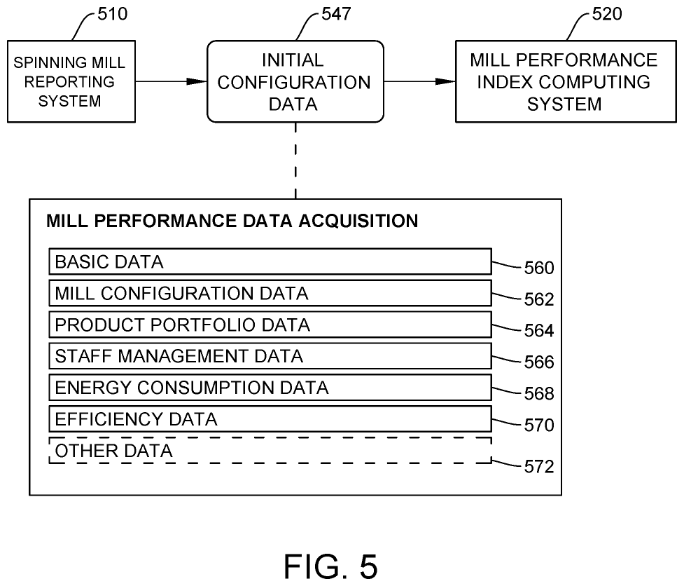

Participation in an MPI system of the nature and character disclosed herein will include at least one configuration step. A flow diagram illustrating an exemplary embodiment of such an initial mill configuration step is depicted in connection with FIG. 5. In one embodiment, a spinning mill reporting system 510 will be utilized in part to access an MPI computing system 520 to set up participation via an initial configuration data template 547 to be used in MPI data acquisition and reporting. At the intake step for initial configuration data (or later editing steps of those data if needed), a series of data concerning the characteristics of the participating mill and its operational parameters are acquired and stored by the MPI computing system 520.

In an exemplary embodiment of the MPI computing system 520, the initial configuration data template 547 is provided in a web accessible format for access by a credentialed user device. In some embodiments the user device can be a component of a spinning mill reporting system 510, and in others the user device may be separate from said system 510, or a combination thereof. In a preferred embodiment the configuration step will involve a series of input prompts designed to guide a user through the configuration step to initialize a participating mill account whereby several types of data are acquired such as basic data 560, mill configuration data 562, product portfolio data 564, staff management data 566, energy consumption data 568, efficiency data 570, and other data 572, for instance.

An exemplary embodiment of the MPI system is provided in which the basic data 560 acquired at the configuration step include account user information and role assignments, for instance, and basic information about the participating mill such as billing information, physical addresses, and the like. In some embodiments, the mill configuration data 562 include information that defines the number of units into which the mill should be divided. Each unit should be defined so that it can be maintained independently from other units, wherein there is no staff or equipment overlap between any two units. Each unit in a mill is provided with an anonymized code at when the mill configuration data 562 are provided during initial setup. In the confidential MPI computing system 520, the actual names of the units as used in practice within the mill can be optionally stored for internal reference, but it is preferred that all mill and unit codes are anonymized. Mill configuration data 562 may also include unit-specific information such as but not limited to, spinning technology identification (e.g., ring spinning), bale openers per unit, carding machines per unit, and total number of carding machines and the number thereof equipped with automatic can changers and automatic can transport systems.

In a preferred embodiment, particularly for ring spinning implementations, the number of draw frame passes is also provided for a unit. In one exemplary embodiment, the counting of draw frame passes is standardized and do not depend upon the inclusion of a combing step, whether regulated or non-regulated machines are used, and whether those machines are used for sliver blending. The number of drawing machines assigned to the first of a plurality of drawing frames is defined, and in mills which utilized the same drawing machine in multiple passages, those drawing machines should only be included in one of the passages. Single and double head drawing machines totals are noted, as well as the connection of those machines to the next process step. In some embodiments, lapping and combing machines are defined per unit, such as the number of lappers total, the number of lappers with auto lap transport, the number of total combing machines, the number of combing machines with an automatic can charger, and the number of combing machines equipped with an automatic can transport system. Similarly, a preferred embodiment collects roving machine data, such as the total number of roving machines, total number of roving positions, number with automatic doffing (positions), and those with no, semi, or full automatic transport systems from the roving to the spinning machines (the total of the aforementioned automatic numbers should equal the total number of roving positions).

Also in a preferred embodiment, ring spinning configuration data is acquired, such as the total number of ring spinning machines, total number of ring spinning positions (spindles) installed, the total number of positions (spindles) equipped with automatic doffing systems, and the total number of positions (spindles) equipped with automatic piecing system. In some embodiments, the mill configuration data also include information related to winding machines are provided, such as the total number of winding machines installed, the number of winding positions installed, how many positions are equipped with a round magazine, how many positions are equipped with a filling station, how many positions are directly linked to the spinning machine (i.e., where no human handling is required). In some embodiments, these data also include how many positions are maintained with a manual package removal without a conveyor belt, semi-automated package removal with a conveyor belt, and fully automated package removal including an automatic transport to the packing station.

In a preferred embodiment, the mill configuration data may also include optional mill level information such as but not limited to the number of packing stations, number of steaming room, number of steamers, number of semi-automated packaging systems, and number of fully automated packing systems.

An exemplary embodiment of the invention further provides for the collection of product portfolio data 564. Product portfolio data 564 may include information such as but not limited to, the number of different articles produced, the quantity of cotton used to produce combed cotton yarns, the percentage of United States cotton used to produce combed cotton yarn, the amount of cotton used to produce carded cotton yarn, the percentage of United States cotton used to produce carded cotton yarn, the material quantity of all cellulosic fibers (e.g., viscose, modal, lyocell, cupro, etc.), the input material amount of all synthetic fibers (e.g., polyester, acrylic, polyamide, polypropylene, etc.), the input material amount of all other fiber materials (e.g., wool, silk, linen, etc.), the input material amount of all filament yarns (e.g., mono or multifilament yarns for core or dual core yarn production), and the input material amount of all recycling materials. In some embodiments, waste management information is also collected to form the product portfolio data 564, such as pneumafil waste percentage, hard waster percentage, rest waste percentage, blow room waste percentage, card waste percentage, and comber noils percentage, for instance.

In a preferred embodiment, the product portfolio data 564 will also include information such as all articles using the usual mill naming system for yarn articles (e.g., “28/1 combed CO compact”). Spinning and winding characteristics for the articles listed in the product portfolio data 564 may also be collected and defined, such as but not limited to output qualities of the winding process, spinning technology (e.g., ring standard, ring core, ring dual core, ring fancy, ring twist spin, ring mélange, ring fancy mélange, compact, compact core, compact dual core, compact fancy, compact twist spin or SIRO, and the like), the yarn count in Number English (Ne), the twist multiplier in Number English, the actual spinning production in grams per position (spindle) hours, an automatically calculated production target, maximum (target) spindle speed, ring diameter in mm, end break level per 1,000 spindle hours, pneumafil waste ratio of the spinning machine, and hard waste ratio of the winding machine. In an exemplary embodiment, blow room to carding information is also provide at configuration, such as waste ratio of all rests, waste ratio of blow room lines, card sliver count in Ne, carding (target) production, and waste ratio of the carding machines, for example. In implementations with combing configuration information, the product portfolio data 564 can include, for instance, comber sliver count in Ne, combing (target) production in kilograms per hour, and comber noil ratios of all combers. For drawing operations, the data 564 may include draw frame sliver output count in Ne, provided preferably per draw frame count. Roving and finishing data are also provided for the articles, including for example, roving count in Ne, roving (target) production in grams per position hours, roving twist multiplier in Ne, and whether steaming is involved in article production. For each article, it is also preferred that the article materials are defined to include the ratio of combed cotton, carded cotton, cellulosic materials, synthetic materials, other fiber materials, recycling materials, United States cotton, and filament yarns (e.g., elastane or texturized polyester).

In a preferred embodiment, staff management data 566 are provided at configuration as well. These data 566 are provided to track and account for staff performance effects on production output, quality and profitability, for instance. In some embodiments, the staff management data 566 include information (on a per unit basis) such as but not limited to employees per department and function, blow room operators, number of employees per shift, maintenance, shift types, contractors, draw frame assignments, and the like. It is preferred that staff are not double counted and where necessary are split between units and departments using fractional apportionments. These data can include production manages that are responsible for an entire unit, and general maintenance employees that are assigned to a unit. Preferably, mill-level supporting staff data are also provided at configuration, with staff assignments tracked for overhead areas such as raw material stock, steaming and packing, yarn stock, quality management, and administration (e.g., upper management, purchasing, sales, human resources, accounting, etc.), for instance. In an exemplary embodiment, staff management data 566 further include information related to absenteeism and labor turnover rates, for instance, which can be tracked at macro (mill) levels, department levels, or other such levels as historic data will provide.

In an exemplary embodiment, the configuration includes the provision of energy consumption data 568, which generally can be used to define energy consumption of units, machines and other such units of production in the mill. In a preferred embodiment, energy considerations can include total pre-spinning machine energy consumption and total spinning/winding machine energy consumption are provided, at the mill level or preferably the unit level. In an exemplary embodiment, mill-level energy consumption data 568 include information for items such as air conditioning consumption, exchange rate of air conditioning, chiller consumption, compressed air consumption, waste collection (HVAC) energy consumption, and rest energy consumption, for instance.

In some embodiments, the MPI system is configured to provide feedback on efficiency, wherein the efficiency data 570 include information at the unit level such as but not limited to actual average stop time of all machines in hours per shift per process step, and actual planned maintenance time in hours per shift of all machines per process step. This is preferably done per blow room and carding steps, taking into account draw frames as well. It should be noted that implementations of the MPI system may also include configuration data for other data 572 that may be relevant to considerations related to production output, product quality and operating margin and profitability analysis, for instance.

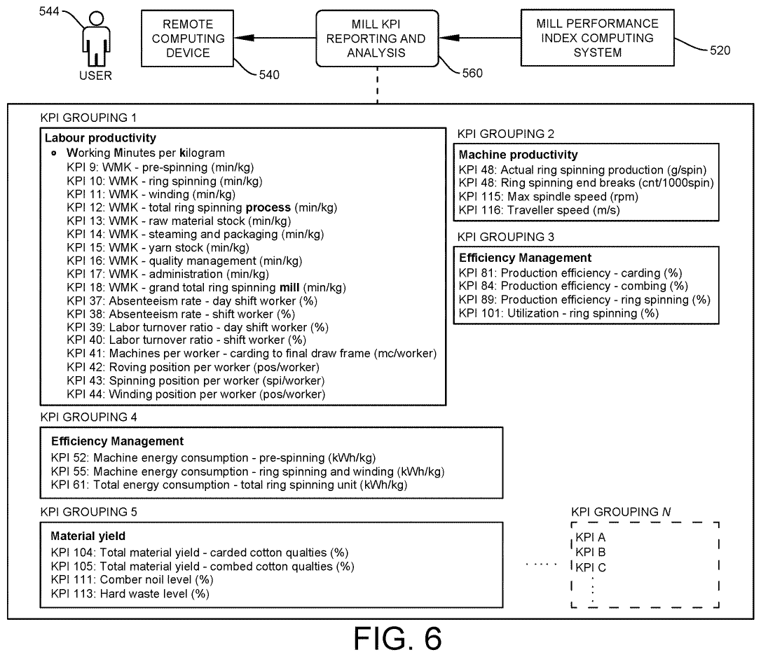

In a preferred embodiment, the MPI computing system 520 is configured to provide a KPI reporting and analysis module 560 that is accessible to a preferably credentialed user 544 via a remote computing device 540. A flow diagram of an exemplary embodiment of the simplified use of a reporting module is depicted in connection with FIG. 6. The reporting module 560 preferably is configured to receive requests for KPI reporting from the user 544 via the remote computing device 540, fetch the necessary data from the MPI computing system 520 (e.g., see display database 228 discussed in connection with FIG. 2).

The reporting module 560 is adapted to provide reporting on a plurality of KPIS organized into a plurality of KPI groupings, or categories. In a preferred embodiment, the KPI groups are divided into one or more of the following categories: labor productivity, machine productivity, efficiency management, energy management, material yield, and other groups up to grouping N, for instance. Those skilled in the art will appreciate that more or less than the groupings provided may be useful in a particular implementation of the invented MPI system without departing from the scope of the claimed invention. Furthermore, the plurality of individual KPIs may largely be defined by any metrics that provide the participating mill with insight into factors impacting production, product and profitability, for instance. An exemplary embodiment of a plurality of KPIs is shown in connection with FIG. 6, but others are available and to a certain extent will depend upon the data provided at the initial mill configuration step.

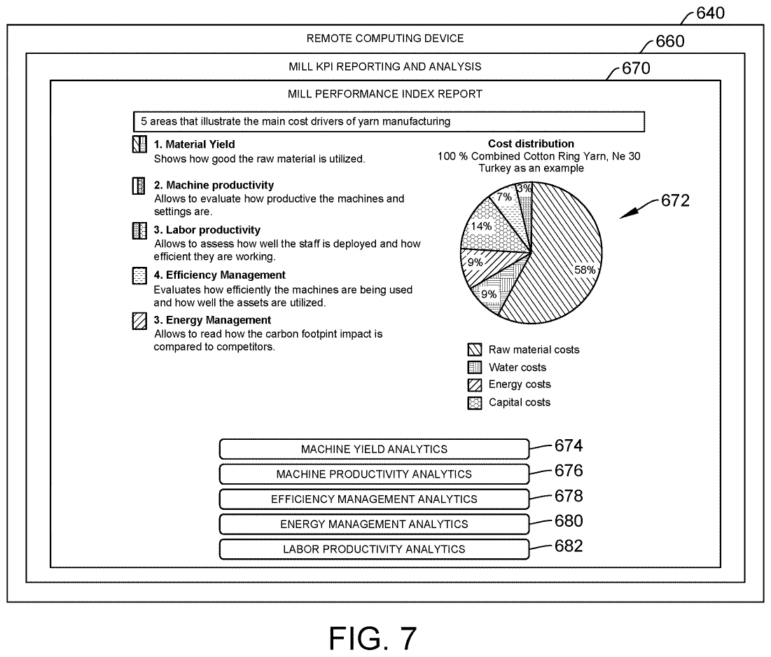

The reporting module is preferably configured for optimal display on a user device in a mobile forward, adaptable manner. An exemplary depiction of a mill performance index report 670 is shown in connection with FIG. 7, wherein the report 670 is displayed on the remote computing device 640 via the KPI reporting and analysis module 660. In general, an MPI report preferably will provide visual displays and optional tabular data to a user that convey in part the main cost drivers of yarn manufacturing in the participating mill using the system. In an exemplary embodiment, a cost distribution chart—here embodied as a pie chart—is displayed for a particular article of interest selected by the user via the report computing device 640, for instance the cost distribution for 100% combed Ne 30 cotton ring yarn.

Links to detailed analytics in a plurality of cost areas are preferably provided for each article being tracked by a participating mill. In an exemplary embodiment, the user is presented with up to five or more primary cost areas in which KPIs and associated analytics are calculated and presented to the user, including but not limited to: (1) material yield; (2) machine productivity; (3) labor productivity; (4) efficiency management; and (5) energy management. In the exemplary embodiment shown in connection with FIG. 7, button links are provided on the MPI Report display 670 to areas such as material yield analytics 674, machine productivity analytics 678 efficiency management analytics 678, energy management analytics 680, and labor productivity analytics 682.

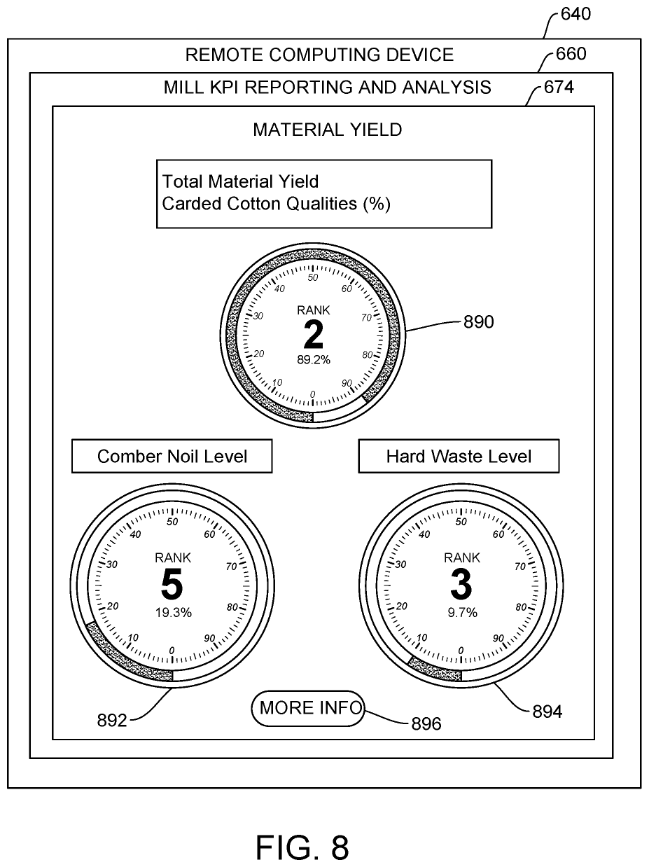

In a preferred embodiment, activating the hyperlink button for material yield analytics 674 will load at least one material yield KPI visualization, such as Material Yield display 674 shown in connection with FIG. 8. The individual reporting KPIs may be selectable for further display at an interim selection screen (not shown), or the KPI category may be presented wholly or partially in visual or tabular form, or a combination thereof. In one exemplary embodiment, the KPI category of material yield is presented with a plurality of reporting KPIs presented in a tachometer visual format as shown in FIG. 8. Here, KPIs in the material yield KPI category are displayed visually, such as total material yield (carded cotton qualities (%)) 890, comber noil level 892 and hard waste level 894. Additional category KPIs can be accessed via expansion button 896 for display convenience in an exemplary embodiment. In a preferred embodiment, industry rankings (or ranking percentiles) are calculated and presented in proximity to the absolute gauge representation of the metric number.

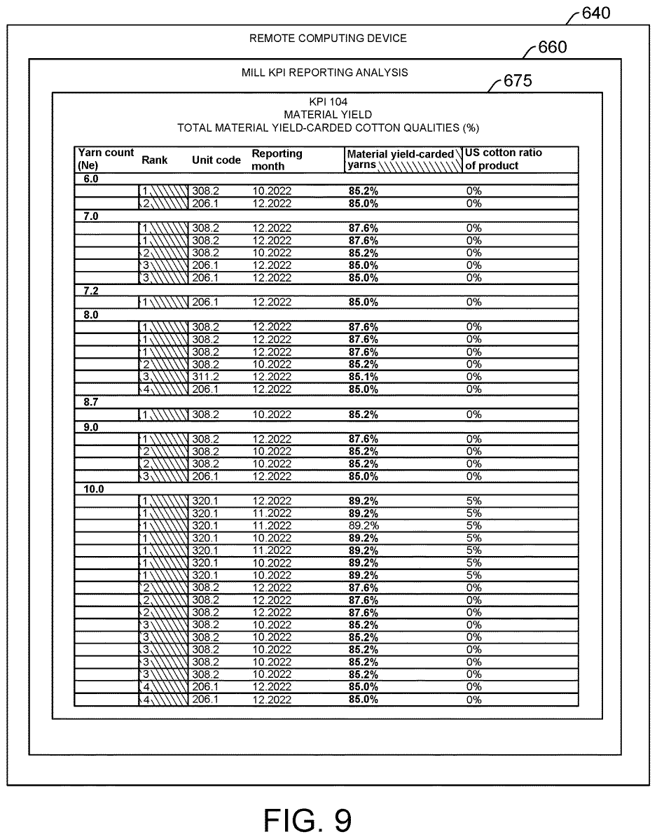

Turning to FIG. 9, an exemplary tabular display 675 of a single KPI (e.g., KPI 104 Total Material Yield-Carded Cotton Qualities (%) as shown in connection with FIG. 6) is depicted through the mill KPI reporting analysis module 660 on a remote computing device 640. Tabular displays such as that shown in connection with FIG. 9 can optionally display rankings and metrics for multiple articles in a more compact space if preferable, for instance.

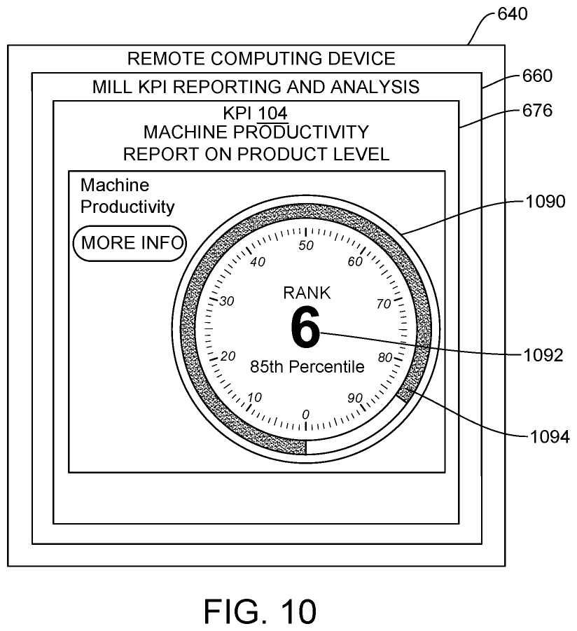

If desired, machine-level productivity reports can be requested via the mill KPI reporting and analysis module 660 via a remote computing device 640. An exemplary embodiment of a module 660 is shown in connection with an exemplary display for product-level machine productivity report 676 illustrated in FIG. 10. Here, the module 660 is configured to display a tachometer feature 1090, which visually demonstrates the relative ranking of a participating mill's machine for a specific product on an industry-wide basis. The display can preferably be adapted to display total ranking 1092 and percentile ranking information 1094 for the selected machine and product, for instance.

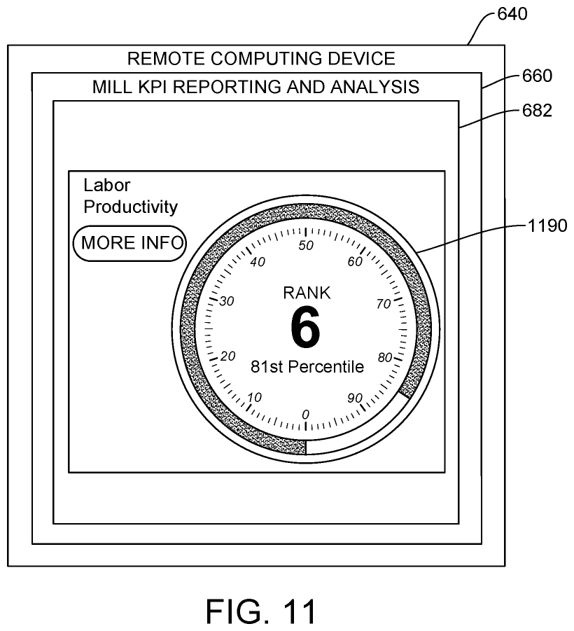

In a similar fashion, many other industry-wide KPIs can be reported to the participating mill such that total rank and percentile ranking for a plurality of relevant KPIs are selectable and viewable. In FIG. 11, an exemplary embodiment of a labor productivity report 682 is shown with a tachometer display 1190 indicating the rank of six with a percentile rank of 81 show therein for an overall mill-level ranking across all units and production articles. This can be very useful to participating mills when evaluating the allocation of labor on at the mill level for things such as administration, maintenance, sales and the like.

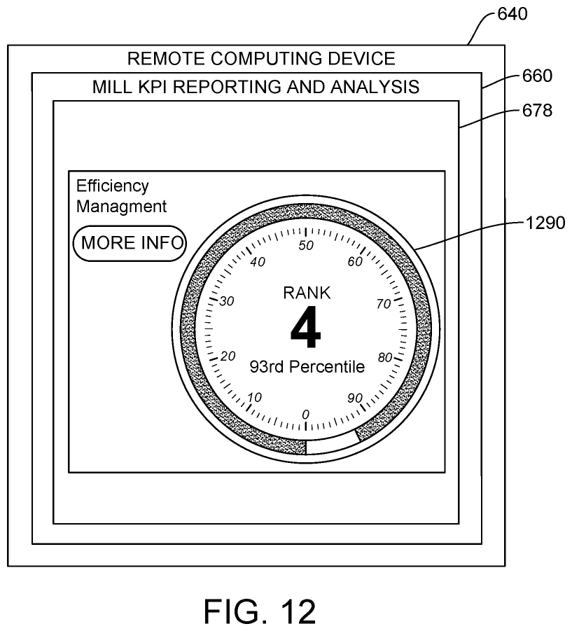

Another exemplary use of a mill level KPI report is shown in connection with report 678 illustrated in FIG. 12. This exemplary embodiment of reporting module 660 usage demonstrates the evaluation of a participating mill's efficiency management in exemplary KPI grouping 4 (shown in connection with FIG. 6). These and many other industry comparisons are made possible by the anonymized reporting of participating mill data in a secure and useful manner. Said reporting includes the calculation and presentation of a wide variety of product-, machine-, unit-, and mill-level KPI reporting metrics that have been heretofore unavailable to production mills around the globe.

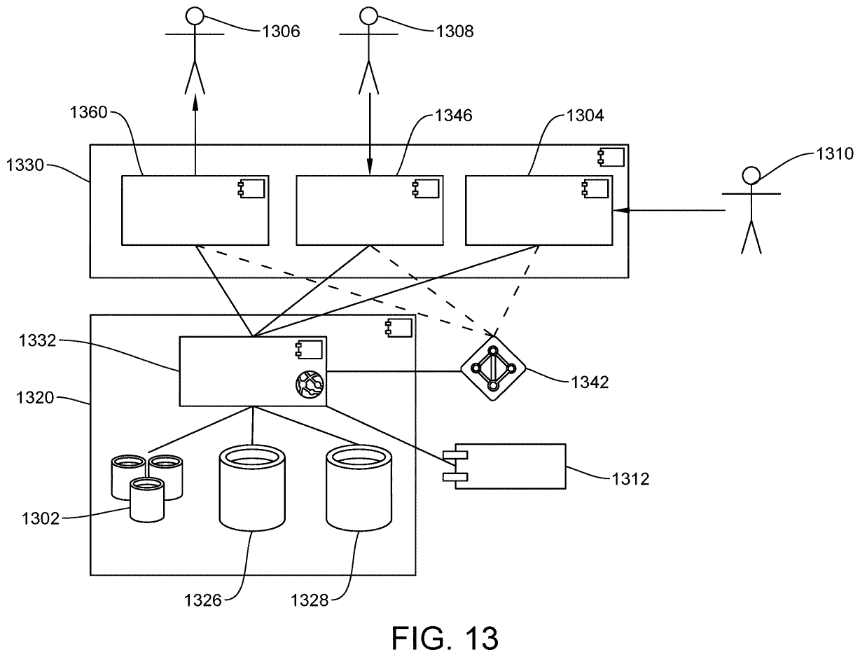

A schematic representation of a preferred embodiment of an MPI system 1300 is shown in connection with FIG. 13. In this embodiment, the MPI computing system 1320 incorporates several features, including a raw mill data database 1326, a display database 1328, an optional viewing/caching database 1302, and an MPI backend application server 1332. In a preferred embodiment, the MPI backend application server 1332 is provided as a .NET 7 framework single application programming interface (API) for all frontend applications, and serves and updates data in the system, hosted within a Microsoft Azure AppService or built on other comparable technologies.

It is preferred that access to the MPI computing system 1320 is controlled by a authentication system. In an exemplary embodiment, an authentication module 1342 such as a Microsoft Identity Platform is used to provide authentication via OAuth/Open ID Connect for convenient integration into participating mill personnel systems. Authenticated access to the MPI computing system 1320 in a preferred embodiment is enabled via one or more web servers 1330 that serve modules such as an MPI display module 1360, an MPI online acquisition mask module 1346, and an MPI administration module 1304. In a preferred embodiment, these modules are implemented as preact single page applications.

In an exemplary embodiment, users are assigned permission levels that can include or prevent access to the various MPI modules available to a user, such as an analyst user role 1306, a reporter user role 1308, or a management/administration user role 1310. In general, analyst users 1306 are permitted to view and filter aggregated data, reporter users 1308 are permitted to report or change raw mill data, and admin users 1310 are permitted to administer other users and mill-level account information (such as subscription data and initial configuration data, for instance).

In a preferred embodiment, the MPI system 1300 also includes a communication service module 1312. The communication service module is preferably configured to facilitate communication between the MPI computing system 1320 (particularly the MPI backend 1332) and users such as but not limited to the exemplary analyst 1306, reporter 1308 and admin 1310 users. Exemplary communications could, for instance, take the form of emails, push notifications, text messages, or the like. These can be used to prompt users for periodic raw data inputs, to notify users of changes in rankings or to report the publication of new KPI data, for example.

Having shown and described a preferred embodiment of the invention, those skilled in the art will realize that many variations and modifications may be made to affect the described invention and still be within the scope of the claimed invention. Additionally, many of the elements indicated above may be altered or replaced by different elements which will provide the same result and fall within the spirit of the claimed invention. It is the intention, therefore, to limit the invention only as indicated by the scope of the claim.

All literature and similar material cited in this application, including, but not limited to, patents, patent applications, articles, books, treatises, and web pages, regardless of the format of such literature and similar materials, are expressly incorporated by reference in their entirety. Should one or more of the incorporated references and similar materials differs from or contradicts this application, including but not limited to defined terms, term usage, described techniques, or the like, this application controls.

As previously stated and as used herein, the singular forms “a”, “an”, and “the” refer to both the singular as well as plural, unless the context clearly indicates otherwise. The term “comprising” as used herein is synonymous with “including”, “containing” or “characterized by” and is inclusive or open-ended and does not exclude additional, unrecited elements or method steps. Although many methods and materials similar or equivalent to those described herein can be used, particular suitable methods and materials are described herein. Unless context indicates otherwise, the recitations of numerical ranges by endpoints include all numbers subsumed within that range. Furthermore, references to “one implementation” are not intended to be interpreted as excluding the existence of additional implementations that also incorporate the recited features. Moreover, unless explicitly stated to the contrary, implementations “comprising” or “having” an element or a plurality of elements having a particular property may include additional elements whether or not they have that property.

The terms “substantially” and “about” describe and account for small fluctuations, such as due to variations in processing or operational ranges that are evident from the disclosure to those skilled in the art, for instance. For example, these terms can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%, or 0%.

Underlined or italicized headings and subheadings are used for convenience only, do not limit the disclosed subject matter, and are not referred to in connection with the interpretation of the description of the disclosed subject matter. All structural and functional equivalents to the elements of the various implementations described throughout this disclosure that are known or later come to be known to those of ordinary skill in the art are expressly incorporated herein by reference and intended to be encompassed by the disclosed subject matter. Moreover, nothing disclosed herein is intended to be dedicated to the public regardless of whether such disclosure is explicitly recited in the above description.

There may be many alternate ways to implement the disclosed technology. Various functions and elements described herein may be partitioned differently from those shown without departing from the scope of the disclosed technology. Generic principles defined herein may be applied to other implementations. Different numbers of a given module or unit may be employed, a different type or types of a given module or unit may be employed, a given module or unit may be added, or a given module or unit may be omitted.

Regarding this disclosure, the term “a plurality of” refers to two or more than two. Unless otherwise clearly defined, orientation or positional relations indicated by terms such as “upper” and “lower” are based on the orientation or positional relations as shown in the Figures, only for facilitating description of the disclosed technology and simplifying the description, rather than indicating or implying that the referred devices or elements must be in a particular orientation or constructed or operated in the particular orientation, and therefore they should not be construed as limiting the disclosed technology. The terms “connected”, “mounted”, “fixed”, etc. should be understood in a broad sense. For example, “connected” may be a fixed connection, a detachable connection, or an integral connection, a direct connection, or an indirect connection through an intermediate medium. For an ordinary skilled in the art, the specific meaning of the above terms in the disclosed technology may be understood according to specific circumstances.

It should be appreciated that all combinations of the foregoing concepts and additional concepts discussed in greater detail herein (provided such concepts are not mutually inconsistent) are contemplated as being part of the disclosed technology. In particular, all combinations of claimed subject matter appearing at the end of this disclosure are contemplated as being part of the technology disclosed herein. While the disclosed technology has been illustrated by the description of example implementations, and while the example implementations have been described in certain detail, there is no intention to restrict or in any way limit the scope of the appended claims to such detail. Additional advantages and modifications will readily appear to those skilled in the art. Therefore, the disclosed technology in its broader aspects is not limited to any of the specific details, representative devices and methods, and/or illustrative examples shown and described. Accordingly, departures may be made from such details without departing from the spirit or scope of the general inventive concept.

Specific details are given in the above description to provide a thorough understanding of the disclosed technology. However, it is understood that the disclosed embodiments and implementations can be practiced without these specific details. For example, circuits can be shown in block diagrams in order not to obscure the disclosed implementations in unnecessary detail. In other instances, well-known circuits, processes, algorithms, structures, and techniques can be shown without unnecessary detail in order to avoid obscuring the disclosed implementations.

Implementation of the techniques, blocks, steps and means described above can be accomplished in various ways. For example, these techniques, blocks, steps and means can be implemented in hardware, software, or a combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, or a combination thereof.

The disclosed technology can be described as a process which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed, but could have additional steps not included in the figure. A process can correspond to a method, a function, a procedure, a subroutine, a subprogram, etc. When a process corresponds to a function, its termination corresponds to a return of the function to the calling function or the main function.

Furthermore, the disclosed technology can be implemented by hardware, software, scripting languages, firmware, middleware, microcode, hardware description languages, or any combination thereof. When implemented in software, firmware, middleware, scripting language, or microcode, the program code or code segments to perform the necessary tasks can be stored in a machine readable medium such as a storage medium. A code segment or machine-executable instruction can represent a procedure, a function, a subprogram, a program, a routine, a subroutine, a module, a software package, a script, a class, or any combination of instructions, data structures, or program statements. A code segment can be coupled to another code segment or a hardware circuit by passing or receiving information, data, arguments, parameters, and/or memory contents. Information, arguments, parameters, data, etc. can be passed, forwarded, or transmitted via any suitable means including memory sharing, message passing, ticket passing, network transmission, etc.

For a firmware or software implementation, disclosed methodologies can be implemented with modules (e.g., procedures, functions, and so on) that perform the functions described herein. Any machine-readable medium tangibly embodying instructions can be used in implementing the methodologies described herein. For example, software codes can be stored in a memory. Memory can be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” can represent one or more memories for storing data, including read only memory (ROM), random access memory (RAM), magnetic RAM, core memory, magnetic disk storage mediums, optical storage mediums, flash memory devices or other machine readable mediums for storing information. The term “machine-readable medium” includes, but is not limited to portable or fixed storage devices, optical storage devices, wireless channels, or various other storage mediums capable of storing that contain or carry instruction(s) or data.

While the principles of the disclosure have been described above in connection with specific apparatuses and methods, it is to be clearly understood that this description is made only by way of example and not as limitation on the scope of the disclosure.

What is claimed:

1. A method comprising the steps of:
acquiring manufacturing data using a facility performance data acquisition module to receive, for each facility in a plurality of facilities:
from an administration user, initial configuration data such that at least one manufacturing unit and at least one manufactured product is associated with each facility in the plurality of facilities;
from a reporter user, a set of operational data from each facility in a plurality of facilities;
storing, in a raw database, the manufacturing data acquired through the facility performance data acquisition module;
calculating, using a KPI analysis module, at least one aggregated manufacturing KPI;
authenticating a user using a remote computing device via an authentication module;
receiving a request to display a manufacturing KPI report from the user via the remote computing device, wherein the manufacturing KPI report includes the at least one aggregated manufacturing KPI; and
displaying the manufacturing KPI report on the remote computing device.

2. The method of claim 1, wherein the set of operational data from each facility in the plurality of facilities is received via an operational data filter mask.

3. The method of claim 2, wherein the operational data filter mask comprises a digital file containing ordered raw facility data corresponding to a defined operational time period.

4. The method of claim 2, wherein the operational data filter mask comprises an automated data acquisition function that receives raw facility data from a reporting system.

5. The method of claim 1, wherein the set of operational data from each facility in the plurality of facilities is received via an operational data filter mask option presented to the reporter user as:
a digital file containing ordered raw facility data corresponding to a defined operational time period; and
an automated data acquisition function that receives raw facility data from a reporting system.

6. The method of claim 1, wherein the user is an analyst user that is permitted to view and filter aggregated data.

7. The method of claim 1, wherein the remote computing device is a mobile device.

8. The method of claim 1, wherein the at least one aggregated manufacturing KPI includes one or more selected from a group of: labor productivity, machine productivity, efficiency management, energy management, and material yield.

9. The method of claim 1, wherein manufacturing data is acquired via a remote computing device comprising a desktop computer system.

10. The method of claim 1, wherein the manufacturing KPI report is displayed on the remote computing device as a visual display comprising a tachometer feature.

11. The method of claim 1, wherein the manufacturing KPI report is displayed as an absolute ranking on the remote computing device.

12. The method of claim 1, wherein the manufacturing KPI report is displayed in a percentile ranking information format.

13. A mill performance index system, comprising:
one or more processors; and
memory storing computer-executable instructions that, when executed by the one or more processors, cause the mill performance index system to perform operations comprising:
acquiring manufacturing data using a facility performance data acquisition module to receive, for each facility in a plurality of facilities:
from an administration user, initial configuration data such that at least one manufacturing unit and at least one manufactured product is associated with each facility in the plurality of facilities;
from a reporter user, a set of operational data from each facility in a plurality of facilities;
storing, in a raw database, the manufacturing data acquired through the facility performance data acquisition module;
calculating, using a KPI analysis module, at least one aggregated manufacturing KPI;
authenticating a user using a remote computing device via an authentication module;
receiving a request to display a manufacturing KPI report from the user via the remote computing device, wherein the manufacturing KPI report includes the at least one aggregated manufacturing KPI; and
displaying the manufacturing KPI report on the remote computing device.

14. A computer program comprising instructions operable to execute the method of any of claims 1 to 12, when run on a suitable apparatus.

15. A computer storage medium comprising the computer program of claim 14.
